(19) United States
(12) Patent Application Publication
(10) Pub. No.: US 2014/0303060 A1
(43) Pub. Date: Oct. 9, 2014

(54) PROCESS FOR DEGRADING A BIOFILM ON SURFACES OF OBJECTS

(71) Applicant: Fraunhofer Gesellschaft Zur Foerderung der angwandten Forschung E.V., Munich (DE)

(72) Inventors: Anke Goekcen, Butzbach (DE); Jochen Wiesner, Giessen (DE); Andreas Vilcinskas, Fernwald (DE); Rainer Fischer, Aachen (DE)

(73) Assignee: Fraunhofer Gesellschaft Zur Foerderung der angewan Forschung E.V., Munich (DE)

(21) Appl. No.: 14/365,225

(22) PCT Filed: Dec. 13, 2012
(86) PCT No.: PCT/EP2012/075376

§ 371 Date: Jun. 13, 2014

Related U.S. Application Data
(60) Provisional application No. 61/579,798, filed on Dec. 23, 2011.

(30) Foreign Application Priority Data
Dec. 14, 2011 (EP) 11193581.3

(51) Int. Cl. C11D 3/386

(52) U.S. Cl. CPC C11D 3/386
USPC 510/392

(57) ABSTRACT

A process for degrading a biofilm on surfaces of objects by means of an extract of a bacterium of the genus Lysobacter, whereby the extract is obtainable by a process comprising the following steps:
culturing Lysobacter on a solid or in a liquid medium;
incubating at a temperature of 20° C. to 40° C. for a duration of from 1 to 15 days;
extraction of at least one component, which is able to degrade a biofilm;
optionally followed by further purification steps, such as ion-exchange chromatography and/or concentration.

The present invention relates to a process for degrading a biofilm on surfaces of objects by means of an extract of a bacterium of the genus Lysobacter, a use of an extract of a bacterium of the genus Lysobacter for degrading a biofilm on surfaces of objects, and a process for preparing the extract according to the invention.

Bacteria often form so-called biofilms in their natural environment. This means that various surfaces produce layers consisting of extracellular material produced by bacteria in addition to the bacterial cells themselves [Romeo (Editor) 2008 Bacterial Biofilms, Series: Current Topics in Microbiology and Immunology, Vol. 322, Springer, Heidelberg]. Other microorganisms, such as algae, fungi and protozoans, may also be contained in biofilms and involved in the formation thereof. The extracellular material consists of proteins, polysaccharides and DNA.

Biofilms can lead to significant impairments in all technical systems in which water, aqueous solutions, suspensions or emulsions are transported or stored [Walker, Surman, Jass (Editors) 2000 Industrial Biofouling: Detection, Prevention and Control, John Wiley & Sons, Chichester UK]. In particular, this is the case for reverse osmosis plants, plumbing and heating systems, drinking water supply facilities, waste water systems, slaughterhouse and dairy filtering systems, washing machines, heat exchangers, machines for papermaking, and piping systems in crude oil production.

In addition, biofilms are the cause of various medical problems [Shirtliff and Leid (Editors) 2009 The Role of Biofilms in Device-Related Infections, Springer, Heidelberg]. Biofilms can favor the formation of particularly virulent and antibiotic-resistant pathogens, or represent a reservoir for such germs. Biofilms on medical devices and implants are of particular importance. Biofilms on bladder catheters are often the cause of catheter-associated urinary tract infections (CAUTI). Biofilms on central-venous catheters can cause sepsis and endocarditis. Biofilms on medical ventilators are an important cause of ventilator-associated pneumonia (VAP). Bacteria and pyrogens originating from biofilms in hemodialysis systems may trigger sepsis.

Biofilms on artificial joints, intramedullary rods, plates, screws and other implants are often the cause of prosthetic implant infections (PII). Biofilms may lead to complications known as periimplantitis on dental implants, and to bacterial endophthalmitis on intraocular lens implants. Biofilms on dental prostheses including removable prostheses may be the cause of gingivitis.

Biofilms on endogenous structures may also result in medical problems. For example, dental plaque is a special form of biofilm. Further, there is evidence of the significance of biofilms in chronic wounds including diabetic ulcer.

For the removal of biofilms on technical systems, aggressive chemicals, such as NaOH, NaClO, CH₃COOH, ClO₂ and H₂O₂, are mainly employed in addition to various mechanical purification methods. Because of possible damage to the materials to be freed from the biofilm, the usefulness of such methods is limited. In the medical field, broad-range antiseptics, such as chlorhexidine gluconate and povidone-iodine, are employed, for example, in the form or oral rinses or disinfection solutions. If used properly, these agents can prevent or delay the formation of a biofilm by killing the microorganisms, but cannot detach an existing biofilm. The application of antibiotics against biofilms is hardly possible, because the microorganisms in the biofilm are hardly accessible to these substances. When implants are colonized by biofilms, surgical replacement is usually necessary. More recent studies show that the formation of biofilms on implants can be inhibited by applying silver nanoparticles.

Enzymes for degrading biofilms offer the advantage that technical surfaces are not damaged, and that aggressive and poisonous chemicals are not employed, so that they can also be readily applied in medicine (Speziale et al., 2008, Curr. Med. Chem. 15, 3185-3195). A biofilm-degrading activity has been described for the enzyme lysostaphin, which is zinc-dependent and disrupts the bacterial cell wall by cleaving the pentaglycine cross bridges (Wu et al. 2003 Antimicrob. Agents Chemother. 47, 3407-3414), and also for the enzyme Phi11 endolysin, which also attacks the bacterial cell wall because of its D-alanyl-glycyl-endopeptidase and N-acetyl-muramyl-L-alanine amidase activities (Sass and Bierbaum 2007 Appl. Environ. Microbiol. 73, 347-352). Since these enzymes merely cause degradation of the cell wall, their activity is not specifically directed against biofilms and especially their extracellular components, so that an optimal effect in a technical application for removing biofilms is not to be expected. In addition, it is known that the repeated freezing and thawing of lysostaphin leads to a reduction of activity (Product information brochure by Sigma-Aldrich, Catalogue No. L4402). Deoxyribonuclease I (DNase I) may also contribute to the degradation of biofilms by cleaving the extracellular DNA (Kaplan 2009 Int. J. Artif. Organs 32, 545-554). Dispersin B is the only enzyme known to hydrolyze a component specific for biofilms, namely poly-beta-1,6-N-acetyl-D-glucosamine. Initially, dispersin B was discovered by genetic complementation of an Actinobacillus actinomycetemcomitans mutant having an atypical colony morphology (Kaplan et al. 2003, J. Bacteriol. 185, 4693-4698). Experiments have shown that the protein will precipitate after the freezing and thawing of dispersin B solutions. In addition, it was found that recombinantly prepared dispersin B, which is not in the form of a fusion protein with a hexahistidine sequence, precipitated in experiments for chromatographic purification. Published protocols for the purification of dispersin B in all cases include metal-affinity chromatography and the use of a detergent (Yakandawala et al. 2009 Ind. Microbiol. Biotechnol. 36, 1297-1305). A low stability and the presence of detergents are disadvantageous for various technical and medical applications. Further, the optimum pH of dispersin B is 5.9, so that dispersin B is less effective at neutral or alkaline pH values.

Besemer et al. report in APPLIED AND ENVIRONMENTAL MICROBIOLOGY, August 2007, p. 4966-4974, about the effect of flow velocity, as the major physical force in stream ecosystems, on biofilm community succession (as continuous shifts in community composition) in microcosms under laminar, intermediate, and turbulent flow. Flow clearly shaped the development of biofilm architecture and community composition, as revealed by microscopic investigation, denaturing gradient gel electrophoresis (DGGE) analysis, and sequencing. While biofilm growth patterns were undirected under laminar flow, they were clearly directed into ridges and conspicuous streamers under turbulent flow. A total of 51 biofilm DGGE bands were detected; the average number ranged from 13 to 16. Succesional trajectories diverged from an initial community that was common in all flow treatments and increasingly converged as biofilms matured. It has been suggested that this developmental pattern was primarily driven by algae, which, as “ecosystem engineers,” modulate their microenvironment to create similar architectures and flow conditions in all treatments and thereby reduce the physical effect of flow on biofilms. The authors concluded that their results suggest a shift from a predominantly physical control to coupled biophysical controls on bacterial community succession in stream biofilms.

EP 0668358 A1 discloses antibiotics WAP-8294A, A1, A2, A4, AX, AX-8, AX-9 and AX-13 or pharmaceutically acceptable salts thereof produced by a strain belonging to the genus Lysobacter; a method for producing the foregoing antibiotic WAP-8294A comprising the steps of cultivating, in a culture medium, a microorganism belonging to the genus Lysobactor and having an ability of producing the antibiotic WAP-8294A to produce the antibiotic and accumulate it in the culture medium; then recovering the antibiotic; as well as an antibacterial composition comprising the antibiotic or pharmaceutically acceptable salts thereof. The novel antibiotic WAP-8294A has an excellent therapeutic effect on infectious diseases developed by infection with Gram-positive bacteria, in particular, MRSA and, therefore, the antibiotic is effective for treating diseases including MRSA infectious diseases developed through infection with Gram-positive bacteria as infectious bacteria.

EP1285928 (A1) discloses that by culturing Lysobacter sp. BMK333-48F3 (deposit number of FERM BP-7477), an antibiotic, tripropeptin Z, tripropeptin A, tripropeptin B, tripropeptin C or tripropeptin D represented by the general formula (I):

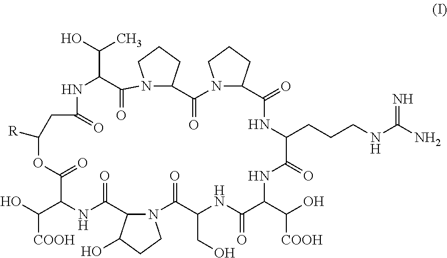

wherein R is 7-methyl-octyl group, 8-methyl-nonyl group, 9-methyl-dodecyl group, 10-methyl-undecyl group or 11-methyl-dodecyl group, is obtained as antibiotics having excellent antibacterial activities against bacteria and having a novel molecular structure. These tripropeptins each have an excellent antibacterial activity against various bacteria and drug-resistant strains thereof, such as methicillin-resistant strains and vancomycin-resistant strains.

O'Sullivan J et al report in J Antibiot (Tokyo). 1988 Dec;41(12):1740-4 a new antibacterial agent, lysobactin, that has been isolated from a species of Lysobacter (ATCC 53042). The antibiotic was recovered from the Lysobacter cell mass by extraction and reversed phase chromatography. Lysobactin is a dibasic peptide with marked activity against Gram-positive aerobic and anaerobic bacteria.

Qian, G. et al. report about identification and characterization of Lysobacter enzymogenes as a biological control agent against some fungal pathogens, Agricultural Sciences in China, Volume 8, Issue 1, January 2009, Pages 68-75, ISSN 1671-2927, DOI: 10.1016/S1671-2927(09)60010-9. Strain OH11, a Gram-negative, nonspore forming, rod-shaped bacterium with powerful antagonistic activity, was isolated from rhizosphere of green pepper and characterized to determine its taxonomic position. 16S rRNA gene sequence analysis revealed that strain OH11 belongs to the Gammaproteobacteria and had the highest degree of sequence similarity to Lysobacter enzymogenes strain C3 (AY074793) (99%), Lysobacter enzymogenes strain N4-7 (U89965) (99%), Lysobacter antibioticus strain (AB019582) (97%), and Lysobacter gummosus strain (AB16136) (97%). Chemotaxonomic data revealed that strain OH11 possesses a quinine system with Q-8 as the predominant compound and C_{15:0} iso, C_{17:1} iso ω9c as the predominant iso-branched fatty acids, all of which corroborated the assignment of strain OH11 to the genus Lysobacter. Results of DNA-DNA hybridization and physiological and biochemical tests clearly showed that strain OH11 was classified as Lysobacter enzymogenes. Strain OH11 could produce protease, chitinase, and β-1,3-glucanase. It showed strong in vitro antifungal activity against Rhizoctonia solani, Sclerotinia scletotiorum, and several other phytopathogenic fungi.

Ten, L. et al. report in International Journal of Systematic and Evolutionary Microbiology (2009), 59, 958-963, that a Gram-negative, aerobic, rod-shaped, non-spore-forming bacterial strain, designated Gsoil 068^{T}, was isolated from soil of a ginseng field in Pocheon Province (South Korea), and was characterized to determine its taxonomic position by using a polyphasic approach. Comparative 16S rRNA gene sequence analysis showed that strain Gsoil 068^{T} belonged to the family Xanthomonadaceae, class Gammaproteobacteria, and was related most closely to Lysobacter brunescens ATCC 29482^{T} and Lysobacter gummosus ATCC 29489^{T} (96.1% sequence similarity). The G+C content of the genomic DNA of strain Gsoil 068^{T} was 67.0 mol %. The detection of a quinone system with ubiquinone Q-8 as the predominant component and a fatty acid profile with iso-C_{15:0}, iso-C_{17:1}ω9C, iso-C_{17:0} and iso-C_{11:0} 3-OH as the major components supported the affiliation of strain Gsoil 068^{T} to the genus Lysobacter. On the basis of its phenotypic properties and phylogenetic distinctiveness, strain Gsoil 068^{T} is considered to represent a novel species of the genus Lysobacter, for which the name Lysobacter panaciterrae sp. nov. is proposed. The type strain is Gsoil 068^{T} (5KCTC 12601^{T} 5DSM 1 7927^{T}).

Surprisingly, it has been found that biofilms can be removed from the surfaces of objects by means of the process according to the invention. The process according to the invention utilizes an extract of a bacterium of the genus Lysobacter, whereby the extract is obtainable by a process comprising the following steps:
culturing Lysobacter on a solid or in a liquid medium;
incubating at a temperature of 20° C. to 40° C. for a duration of from 1 to 15 days;
extraction of at least one component from the culture medium, which component is able to degrade a biofilm;
optionally followed by further purification steps, such as ion-exchange chromatography and/or concentration.

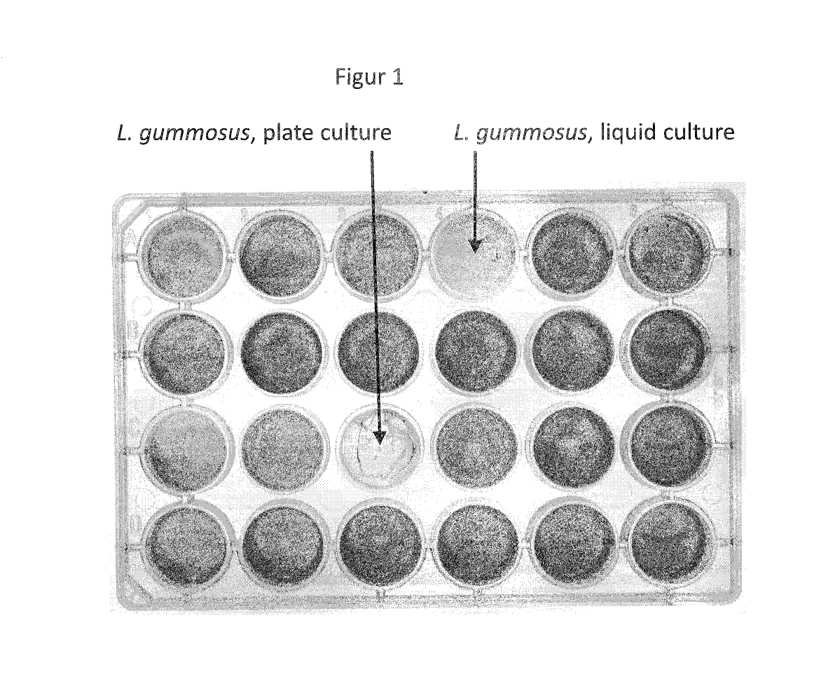

FIG. 1 shows the result of a test for determining the biofilm-degrading activity with preparations obtained from different microorganisms after culturing in liquid medium or on solid medium.

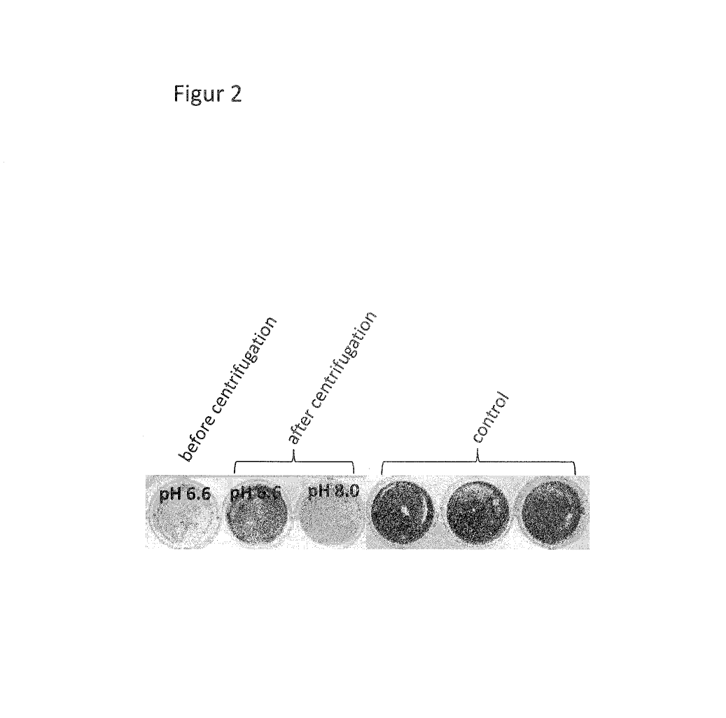

FIG. 2 shows the result of a test for determining the biofilm-degrading activity with preparations of L. gummosus before centrifugation, after centrifugation and after adjusting the pH.

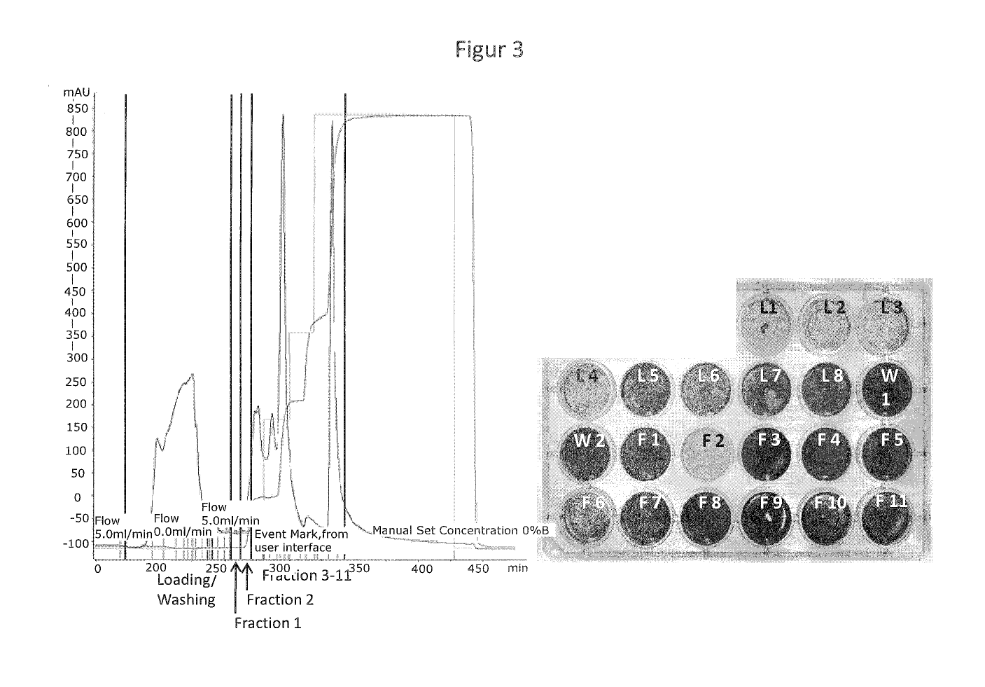

FIG. 3 shows the results of Q sepharose chromatography and of the corresponding test for biofilm-degrading activity of a preparation of extracellular material of the microorganism L. gummosus according to the invention.

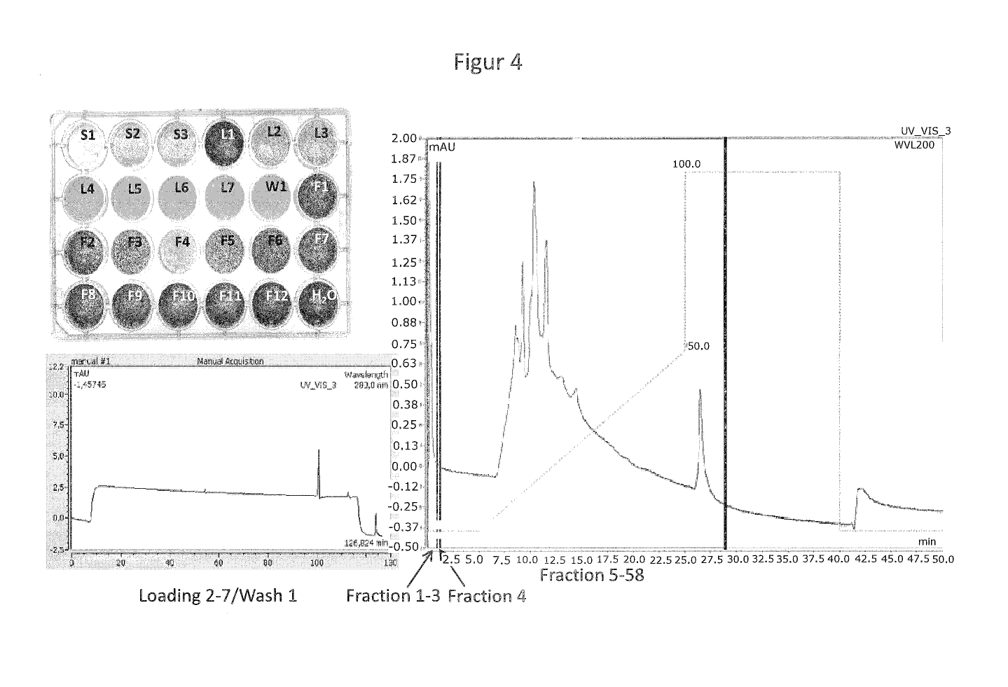

FIG. 4 shows the results of Mono S chromatography and of the corresponding test for biofilm-degrading activity with fraction 2 from the Q sepharose chromatography.

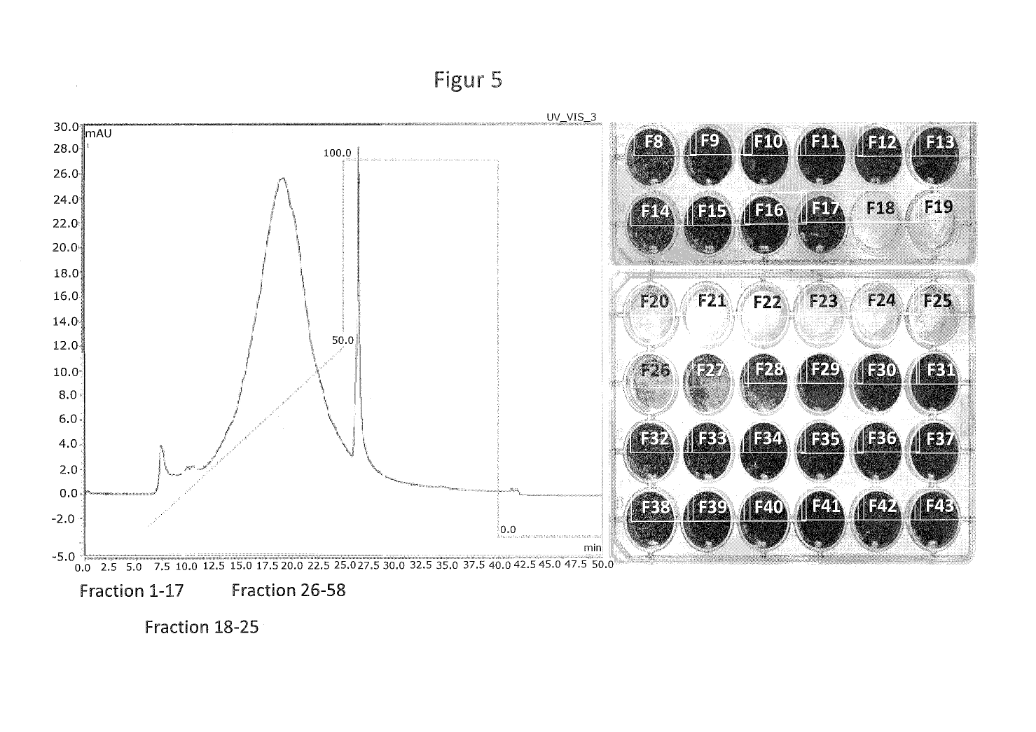

FIG. 5 shows the results of Mono Q chromatography and of the corresponding test for biofilm-degrading activity with the flow-through from the Mono S chromatography.

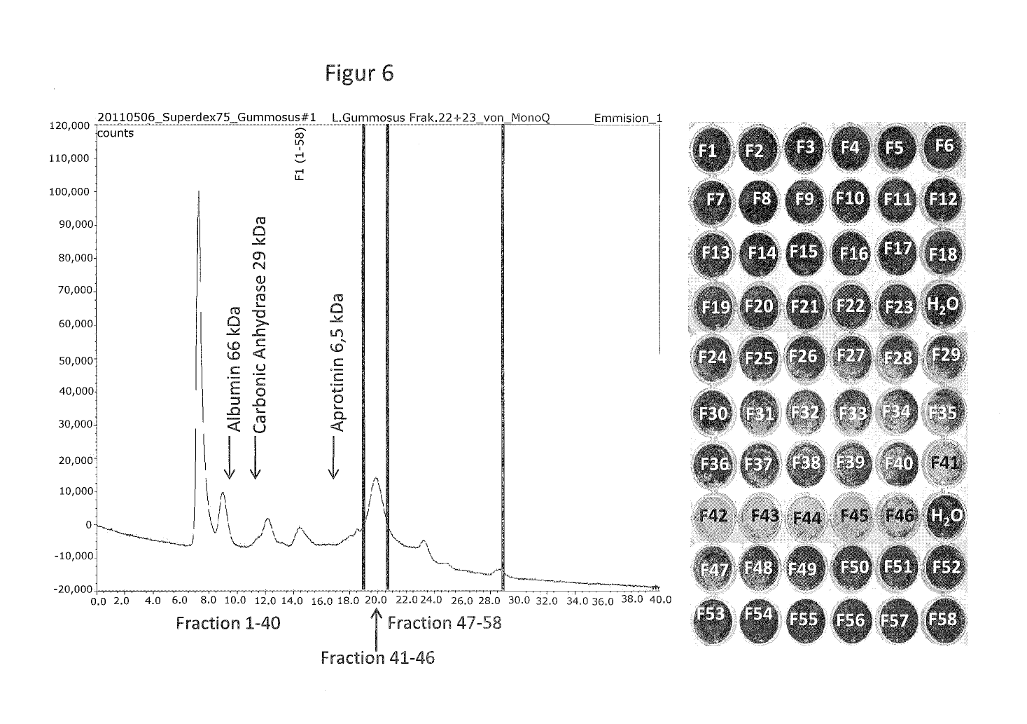

FIG. 6 shows the results of Superdex 75 chromatography and of the corresponding test for biofilm-degrading activity with the pooled fractions 21 and 22 from the Mono Q chromatography.

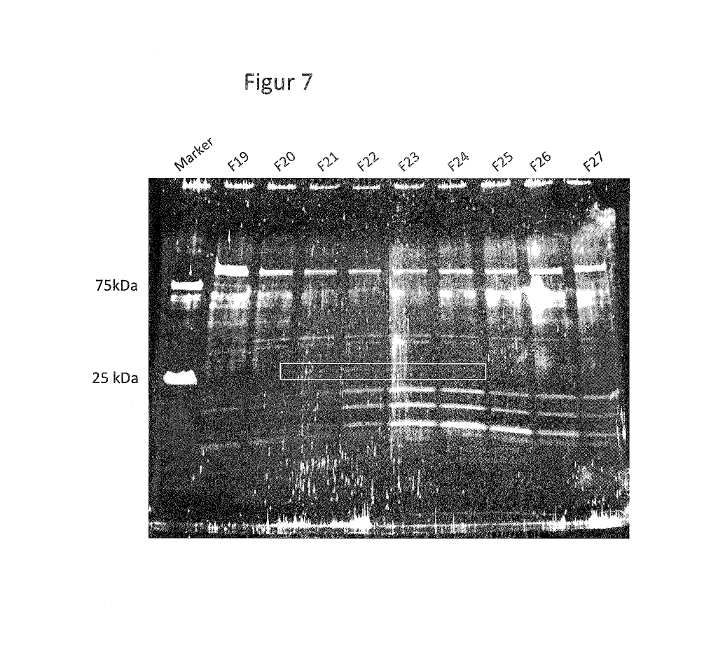

FIG. 7 shows the results of an SDS PAGE analysis of fractions 19 to 27 from the Mono Q chromatography.

In a preferred embodiment of the process according to the invention, the bacteria of the genus Lysobacter are selected from the group consisting of Lysobacter antibioticus, Lysobacter enzymogenes, Lysobacter gummosus, Lysobacter panaciterrae and Lysobacter sp. DSM 3655.

In a particular embodiment of the invention the bacteria are Lysobacter gummosus. The strain Lysobacter gummosus (DSM 6980) is particularly suitable.

The at least one component that can be employed in the process according to the invention may be recovered, for example, from the extracellular space of the microorganism. At least one enzyme that can be employed in the process according to the invention may be recovered from the intracellular space. At least one enzyme that can be employed in the process according to the invention may be recovered from membrane vesicles which are secreted from the producing bacteria.

In a preferred embodiment of the invention the at least one component is recovered from the extracellular space of the microorganism.

According to the invention, the term “degradation of biofilms” means the partial or complete detachment of macroscopic or microscopic parts of a biofilm from a surface, especially the cleaving or dissolving of at least one molecular structure from a biofilm. Biofilm-degrading enzymes that may be employed according to the invention are also capable of preventing the formation of biofilms.

Molecular structures within the meaning of the invention may be cell components of the microorganisms contained in biofilms, or components of the extracellular material produced by the microorganisms.

The at least one component that can be used in the process according to the invention may also be employed to cleave molecular structures in a pure form or in admixtures into smaller molecular units independently of the presence of a biofilm.

The at least one component that can be employed in the process according to the invention is suitable for the degradation of different types of biofilms. The biofilms may be formed by one or more microbial species, by one dominant species, or by a complex mixed population. In addition, the biofilms may also contain mircoorganisms that are identical with the mircoorganisms according to the invention utilized for preparing the biofilm-degrading components. In particular, the component that can be used in the process according to the invention comprises at least one enzyme.

In a preferred embodiment, the invention serves for the degradation of biofilms containing poly-β-1,6-N-acetyl-D-glucosamine. This polymer may be in a partially deacetylated form. The formation of this polymer is effected, in particular, by microorganisms in whose genome ica or pga genes or homologues of these genes occur, ica or pga genes are described in Götz 2002 Mol. Microbiol. 43, 136713-78; Wang et al. 2004 J. Bacteriol. 186, 2724-2734; Itoh et al. 2008, J. Bacteriol. 190, 3670-3680; Choi et al. 2009, J. Bacteriol. 5953-5963. They occur, for example, in particular strains of bacteria of the genus Staphylococcus, especially Staphylococcus epidermidis, and/or Escherichia coli or Acinetobacter baumannii. The pga genes are also contained in enterohemorrhagic Escherichia coli bacteria. The mentioned genes may be located on the bacterial chromosome, on lytic or lysogenic phages, and on extrachromosomal genome elements.

In a preferred embodiment the present invention is employed for degrading biofilms from bacteria of the genus Staphylococcus, especially Staphylococcus epidermidis.

The process according to the invention is suitable, in particular, for removing biofilms that are present on surfaces of technical systems and devices employed in hygiene-relevant areas.

The preparations that can be employed in the process according to the invention are particularly suitable for the cleaning of reverse osmosis membranes and filtering systems in slaughterhouses and dairies. Another preferred application is the cleaning of hemodialysis systems, medical ventilators, catheters, and dental prostheses. The preparations may also be applied to surfaces to be protected against the formation of biofilms, or incorporated in the corresponding materials. This application is particularly suitable for the preparation of catheters, implants and prostheses including dental prostheses. The preparations or proteins that can be employed according to the invention are also used in combinations with disinfectants, antibiotics or other antimicrobially active substances.

The present invention also relates to an extract containing at least one biofilm-degrading component, e.g. an enzyme obtainable from the extracellular space of a microorganism of the genus Lysobacter.

The extract according to the invention is obtainable by a process comprising the following steps:
culturing Lysobacter in a medium comprising 10 g of skimmed-milk powder, 1 g of yeast extract, 15 g of agar, and water q.s. 1 liter;
incubating at a temperature of 28° C. to 30° C. for a duration of 3 days;
extraction of the at least one component which is able to degrade a biofilm by means of water or an aqueous solution containing buffer salts;
optionally followed by further purification steps, such as anion-exchange chromatography.

The invention also discloses a concentrate obtainable from the extract according to the invention by at least one concentrating step.

The invention also discloses objects that are coated or impregnated with an extract used according to the invention or with a concentrate used according to the invention.

In particular, the objects disclosed by the invention are selected from the group consisting of elements of technical systems, especially with hygiene-relevant applications, medical systems, appliances and devices.

The present invention further relates to a process for preparing the extract for use according to the invention, comprising the steps of:
culturing Lysobacter on a solid or in a liquid medium;
incubating at a temperature of 20° C. to 40° C. for a duration of from 1 to 15 days;
extraction of the at least one component which is able to degrade a biofilm;
optionally followed by further purification steps, such as ion-exchange chromatography and/or concentration.

In a process according to the invention for preparing the preparations containing biofilm-degrading components or enzymes, the microorganisms can be cultured on different media usually employed in microbiology. The culture can be performed in liquid media or in a particularly suitable way on solid media. A skimmed-milk medium consisting of 10 g of skimmed-milk powder, 1 g of yeast extract, 15 g of agar, and water q.s. 1 liter is particularly suitable. The incubation is preferably effected at temperatures of from 20 to 40° C. A temperature of from 28 to 30° C. is particularly suitable. The incubation time can be from 1 to 15 days. Preferably, an incubation is effected for 2 to 4 days, especially 3 days.

For preparing the component which may comprise enzymes, cell lysates or culture supernatants can be used. Preferably, extracellular components e.g. proteins are extracted from the microbial growth of cultures on a solid medium. The components may be extracted from the medium on which the microorganisms were cultured. The extraction is effected, for example, by stirring the material with water or buffer. Especially when the preferred organism L. gummosus is used according to the invention, a suitable step for homogenizing the material, for example, by rotating cutters, is advantageous. In a preferred embodiment of the process according to the invention, an ultrasonic treatment resulting in a reduction of viscosity is performed.

The raw extracts obtained can be used with or without removal (for example, by centrifugation or filtration) of bacterial cells and other particulate material. In a particularly preferred embodiment of the invention, a purification or enrichment of at least one biofilm-degrading component is effected by methods known to the skilled person, as described, for example, in Rehm and Letzel 2010, Der Experimentator: Proteinbiochemie, Proteomics, Spektrum Akademischer Verlag, Heidelberg. In a preferred process, the enrichment of at least one biofilm-degrading component from L. gummosus is effected by anion-exchange chromatography.

The detection of the biofilm-degrading activity of the preparations according to the invention can be effected by suitable in vitro methods. This can be done using biofilms formed under natural conditions, or model biofilms produced under controlled conditions in a laboratory. A test in which a biofilm is formed by the bacterium Staphylococcus epidermidis RP62A on plastic cell culture plates is preferably employed. The evaluation of the biofilm-degrading activity can be effected directly by visual inspection or after staining with suitable dyes, such as crystal violet or safranin. A quantification is possible after extracting the dye with a solvent (for example, ethanol) and photometric measurement.

### EXAMPLE 1

### Identification of the Microorganism

A screening for microorganisms that produce extracellular biofilm-degrading or biofilm-detaching components was performed. The screening was performed as follows:

Each microorganism strain to be examined was cultured at 30° C. both in a liquid medium and on a solid one. After 3, 7 and 10 days each, samples for the activity test were obtained. Thus, the liquid cultures were centrifuged off, and the supernatant was employed for the test. For obtaining the samples from the cultures on a solid medium, the grown layer comprising the bacteria and extracellular material was scraped off the culture plates and transferred to a beaker. The material was admixed with water (4 ml per gram of wet weight) and incubated with stirring at room temperature for 15 min. After centrifugation, the supernatant was employed for the test.

Biofilms formed by Staphylococcus epidermidis were used for performing the activity test. S. epidermidis RP62A was cultured in TSB medium at 37° C. on 24-well cell culture plates over night. The culture broth was pipetted off, and the biofilm formed on the bottom of the cell culture plate was washed with water. The biofilm in the individual wells was added with 0.2 ml each of the solutions to be tested. After incubation at 28° C. over night under slight horizontal rotation (50 rpm), the plates were visually inspected for the partial or complete disappearance of the biofilm. For further evaluating the activity, the biofilms remaining after incubation were stained with crystal violet. Thus, the liquid was pipetted from the wells of the cell culture plates, the wells were washed with water, and 0,2 ml each of crystal violet solution (10 mg/ml in H₂O) was added. After 10 min at room temperature, the dye solution was pipetted off, and the wells were washed with water. After drying, the remaining stained biofilm was visually evaluated and photographically documented.

A degradation or detachment of the biofilm was observed with samples of the following microorganisms:

Lysobacter antibioticus, Lysobacter enzymogenes, Lysobacter gummosus, Lysobacter panaciterrae, Lysobacter sp. (DSM 3655).

In all cases, the activity was higher if the samples were obtained from microorganisms that had been cultured on a solid medium (FIG. 1).

A particularly high activity was observed with samples obtained from the bacterium Lysobacter gummosus.

### EXAMPLE 2

### Preparation of a Biofilm-Degrading Homogenizate from L. gummosus

L. gummosus was cultured in 20 large Petri dishes (diameter 145 mm) on skimmed-milk medium at 28° C. for 3 days. The grown layer comprising the bacteria and extracellular material was scraped off and stirred with 4 times its volume of water. The highly viscous jelly-like mass obtained was comminuted in a mixing device with rotating cutters. After centrifugation (75,000×g, 30 min, 4° C.), the supernatant was treated with ultrasound to further reduce the viscosity. After another centrifugation, a low-viscous, pipettable, slightly yellowish-brown liquid was obtained. A microscopic examination showed that the liquid is free of bacterial cells. The pH was 6.6. Testing in an activity test showed that the homogenizate has significant biofilm-degrading and/or biofilm-detaching activity. The activity of the liquid clarified by centrifugation could be clearly increased by adjusting the pH to 8.0 (FIG. 2).

### EXAMPLE 3

### Preparation of a Biofilm-Degrading Fraction by Anion-Exchange Chromatography

The cleared homogenizate as described in Example 2 was used as the starting material. The pH was adjusted to 8.0 by adding Tris [tris(hydroxymethyl)aminomethane] base. Thereafter, the conductivity was 6.2 mS. The chromatography was effected on a strong anion-exchange column [Q-Sepharose FastFlow (GE Healthcare), 5 cm diameter, 5 cm length]. The column was equilibrated with 20 mM Tris-HCl, pH 8.0. After applying the homogenizate with a flow rate of 5 ml/min, the column was washed with 20 mM Tris-HCl, pH 8.0. The elution was effected with a step gradient with 100, 300, 500 and 1,000 mM NaCl in the same buffer. The real course of the gradient was followed by a conductivity detector. Testing the individual fractions showed that the main activity was eluted with the flank from 0 to 100 mM NaCl (fraction 2). With this fraction, the degradation of the biofilm could be observed already after 2 hours. After incubation over night, some weaker activity could also be observed in the flow-through from the loading of the column (FIG. 3).

### EXAMPLE 4

### Characterization of the Biofilm-Degrading Activity by Cation-Exchange Chromatography

Fourty-five milliliters of fraction 2 obtained as described in Example 3 was diluted with 150 ml of 10 mM Na phosphate buffer, pH 6.1. The conductivity of the diluted solution was 13.2 mS. The solution was applied to a Mono S 5/50 GL column (GE Healthcare) equilibrated with 10 mM Na phosphate buffer, pH 6.1, at a flow rate of 1 ml/min. After washing with the same buffer, the elution was effected with a linear gradient of from 0 to 500 mM NaCl in the same buffer over 20 min. In this experiment, the activity was observed mainly in the flow-through obtained during the loading (samples L2 to W1 in FIG. 4). In addition, activity was observed in fraction 4. Because of the dead volume of the column and the chromatography unit, it is to be concluded that this fraction was obtained before the onset of the salt gradient (FIG. 4).

EXAMPLE 5

### Characterization of the Biofilm-Degrading Activity by Anion-Exchange Chromatography

The active flow-through (250 ml) obtained as described in Example 4 was admixed with 150 ml of buffer (5 mM Tris-HCl, pH 8.0) and additionally with 210 ml of H₂O. Thereafter, the conductivity was 10.7 mS. The solution was applied to a Mono Q 5/50 GL column (GE Healthcare) equilibrated with 5 mM Tris-HCl buffer, pH 8.0, at a flow rate of 1 ml/min. After washing with the same buffer, the elution was effected with a linear gradient of from 0 to 500 mM NaCl in the same buffer over 20 min. Fractions of 1 ml were collected. The main activity was eluted from the column with the first fourth to third of the gradient.

In fractions F21 and F24, the degradation of the biofilm could be observed already after 2 hours. After incubation over night, a degradation of the biofilm could also be observed in fractions F18 to F28 (FIG. 5).

### EXAMPLE 6

### Characterization of the Biofilm-Degrading Activity by Gel Permeation Chromatography

The fractions F21 and F22 obtained as described in Example 5 were pooled and concentrated to 0.2 ml by ultrafiltration through a 10 kDa filter. A check in an activity test showed that the main activity was in the retentate. A clearly weaker activity was observed in the permeate. The retentate was applied to a Superdex 75 10/300 column (GE Healthcare) equilibrated with 100 mM NaCl, 20 mM Tris-HCl, pH 8.0. Isocratic elution was performed with the same buffer at a flow rate of 1 ml/min. Fractions of 1 ml were collected. The main activity was observed in fractions 41 to 46 after the smallest molecular weight standard (aprotinin; 6.5 kDa) (FIG. 6). This indicates that at least one of the components being causative for the biofilm-degrading activity is characterized by a small molecular mass or by its ability to interact with the column matrix thereby being delayed in chromatography.

### EXAMPLE 7

### Characterization of the Biofilm-Degrading Preparation by Gel Electro-Phoresis

The fractions F19 and F27 obtained by anion-exchange chromatography as described in Example 5 were analyzed by a standard method by SDS PAGE (sodium dodecyl sulfate polyacrylamide gel electrophoresis) under reducing conditions in a 4-20% Mini-PROTEAN TGX precast gel (Biorad). The visualization of the protein bands was effected by staining with the fluorescent dye Flamingo fluorescent gel stain (Biorad). The band patterns depicted in FIG. 7 were obtained. In the range around 25 kDa, a weak band occurred whose intensity correlated with the activity observed in the biofilm degradation test.

1. A process for degrading a biofilm on surfaces of objects by means of an extract of a bacterium of the genus Lysobacter, whereby the extract is obtainable by a process comprising the following steps;
culturing Lysobacter on a solid or in a liquid medium;
incubating at a temperature of 20° C. to 40° C. for a duration of from 1 to 15 days;
extraction of at least one component, which is able to degrade a biofilm;
optionally followed by further purification steps, such as ion-exchange chromatography and/or concentration,

2. The process according to claim 1, characterized in that said bacteria of the genus Lysobacter are selected from the group consisting of Lysobacter antibioticus, Lysobacter enzymogenes, Lysobacter gummosus, Lysobacter panaciterrae and Lysobacter sp. DSM 3655.

3. The process according to claim 1, characterized in that said at least one component comprises at least one enzyme which recovered from the extracellular space of the microorganism.

4. The process according to claim 1, characterized in that said biofilm is formed by one or more microbial species, by one dominant species, or by a complex mixed population.

5. The process according to claim 1, characterized in that said biofilm contains poly-β-1,6-N-acetyl-D-glucosamine.

6. The process according to claim 1, characterized in that said biofilm has been especially Staphylococcus epidermidis, and/or Escherichia coli or Acinetobacter baumannii.

7. The process according to claim 6, characterized in that the genera and species mentioned in claim 6 are present singly or in associations in the biofilm.

8. The process according to claim 1, characterized in that said biofilm is present on surfaces of technical systems and devices employed in hygiene-relevant areas.

9. Use of an extract of a bacterium of the genus Lysobacter for degrading a biofilm on surfaces of objects, whereby the extract is obtainable by a process comprising the following steps:
culturing Lysobacter on a solid or in a liquid medium;
incubating at a temperature of: 20° C. to 40° C. for a duration of from 1 to 15 days;
extraction of at least one component, which is able to degrade a biofilm;
optionally followed by further purification steps, such as ion-exchange chromatography and/or concentration.

10. The use of claim 9 whereby the extract is obtainable by a process comprising the following steps:
culturing Lysobacter in a medium comprising 10 g of skimmed-milk powder, 1 g of yeast extract, 15 g of agar, and water q.s. 1 liter;
incubating at a temperature of 28° C. to 30° C. for a duration of 3 days;
extraction of the at least one component which is able to degrade a biofilm by means of water or an aqueous solution containing buffer salts;
optionally followed by further purification steps, such as anion-exchange chromatography.

11. A process for preparing an extract for use in claim 9, comprising the steps of:
culturing Lysobacter on a solid or in a liquid medium;
incubating at a temperature of 20° C. to 40° C. for a duration of from 1 to 15 days;
extraction of the at least one component which is able to degrade a biofilm;
optionally followed by further purification steps, such as ion-exchange chromatography and/or concentration.
